(19) United States
(12) Patent Application Publication
(10) Pub. No.: US 2018/0262827 A1
(43) Pub. Date: Sep. 13, 2018

(54) Thermally Adjustable Headphone System

(71) Applicant: Fluent Audio, Inc., Woodbury, MN (US)

(72) Inventor: Joseph Thomas Vaughan, Woodbury, MN (US)

(73) Assignee: Fluent Audio, Inc.

(21) Appl. No.: 15/454,796

(22) Filed: Mar. 9, 2017

(51) Int. Cl. H04R 1/10

(52) U.S. Cl. CPC H04R 1/1041; H04R 1/1008; H04R 1/1091

(57) ABSTRACT

A thermally adjustable headphone system which integrates thermal members to provide heating and/or cooling comfort to the wearer. The thermally adjustable headphone system generally includes headphones having a pair of ear pieces adapted to be worn on, near, or around the ears of an individual. Each of the ear pieces may include a thermal member which is adapted to heat or cool in response to external stimuli. One embodiment illustrates thermal members which act as thermoelectric coolers in response to an electrical current from a power source. Another embodiment illustrates exciters which, in response to an electrical current from a power source, cause a magnetic field which causes a thermal change in chemical compounds stored within the ear pieces. In either case, the thermal members radiate heat or apply cooling through the ear pieces to heat or cool the individual wearing the headphones.

### CROSS REFERENCE TO RELATED APPLICATIONS

Not applicable to this application.

### STATEMENT REGARDING FEDERALLY SPONSORED RESEARCH OR DEVELOPMENT

Not applicable to this application.

### BACKGROUND

### Field

Example embodiments in general relate to a thermally adjustable headphone system which integrates thermal members to provide heating and/or cooling comfort to the wearer.

### Related Art

Any discussion of the related art throughout the specification should in no way be considered as an admission that such related art is widely known or forms part of common general knowledge in the field.

Headphones and headsets have become ubiquitous in modern society. Headphones generally include ear pieces which are worn by an individual to play various audio signals, such as music from a smart phone or communications via a radio transmitter/receiver.

It is well known that a large percentage of body temperature may be regulated through the head of an individual. While headphones are commonly used, it is often not comfortable to wear both headphones as well as warming articles such as ear muffs in cold environs. Similarly, as headphones and headsets are commonly used in exercising, while playing video games, communicating via interface with numerous transceiver devices, it would be desirable to provide cooling through headphones to cool individuals wearing headphones in warmer environs to improve comfort and increase productivity

### SUMMARY

An example embodiment is directed to a thermally adjustable headphone system. The thermally adjustable headphone system includes headphones having a pair of ear pieces adapted to be worn on, near, or around the ears of an individual. Each of the ear pieces may include a thermal member which is adapted to heat or cool in response to external stimuli. One embodiment illustrates thermal members which act as thermoelectric coolers in response to an electrical current from a power source. Another embodiment illustrates exciters which, in response to an electrical current from a power source, cause a magnetic field which causes a thermal change in chemical compounds stored within the ear pieces. In either case, the thermal members radiate heat or apply cooling through the ear pieces to heat or cool the individual wearing the headphones.

There has thus been outlined, rather broadly, some of the embodiments of the thermally adjustable headphone system in order that the detailed description thereof may be better understood, and in order that the present contribution to the art may be better appreciated. There are additional embodiments of the thermally adjustable headphone system that will be described hereinafter and that will form the subject matter of the claims appended hereto. In this respect, before explaining at least one embodiment of the thermally adjustable headphone system in detail, it is to be understood that the thermally adjustable headphone system is not limited in its application to the details of construction or to the arrangements of the components set forth in the following description or illustrated in the drawings. The thermally adjustable headphone system is capable of other embodiments and of being practiced and carried out in various ways. Also, it is to be understood that the phraseology and terminology employed herein are for the purpose of the description and should not be regarded as limiting.

### BRIEF DESCRIPTION OF THE DRAWINGS

Example embodiments will become more fully understood from the detailed description given herein below and the accompanying drawings, wherein like elements are represented by like reference characters, which are given by way of illustration only and thus are not limitative of the example embodiments herein.

FIG. 1 is a perspective view of a thermally adjustable headphone system with curved ear pieces in accordance with an example embodiment.

FIG. 2 is a perspective view of a thermally adjustable headphone system with flattened ear pieces in accordance with an example embodiment.

FIG. 3 is a sectional view of a thermally adjustable headphone system which includes a thermoelectric cooler with a single cord in accordance with an example embodiment.

FIG. 4 is a sectional view of a thermally adjustable headphone system which includes a thermoelectric cooler with multiple cords in accordance with an example embodiment.

FIG. 5 is a sectional view of a thermally adjustable headphone system which includes exciters and chemical compounds in accordance with an example embodiment.

FIG. 6 is a frontal view of a thermally adjustable headphone system being worn by an individual in accordance with an example embodiment.

FIG. 7 is a frontal view of a thermally adjustable headphone system being worn by an individual with active thermal members in accordance with an example embodiment.

FIG. 8 is an exploded perspective view of an ear piece including a thermoelectric cooler and thermal sink in accordance with an example embodiment.

FIG. 9 is an exloded perspective view of an ear piece including an exciter and chemical compound in accordance with an example embodiment.

FIG. 10 is a block diagram illustrating a thermally adjustable headphone system including thermoelectric coolers in accordance with an example embodiment.

FIG. 11 is a block diagram illustrating a thermally adjustable headphone system including exciters in accordance with an example embodiment.

### DETAILED DESCRIPTION

### A. Overview.

An example thermally adjustable headphone system generally comprises headphones 20 having a pair of ear pieces 22, 24 adapted to be worn on, near, or around the ears of an individual. Each of the ear pieces 22, 24 may include a thermal member 60, 70 which is adapted to heat or cool in response to external stimuli. The thermal member 60, 70 is connected to the ear piece 22, 24 such that heating or cooling from the thermal member 60, 70 is transferred to the ear piece 22, 24. In some embodiments, the thermal members 60, 70 may be connected behind the ear pieces 22, 24 (on the side opposite the ear). One embodiment illustrates thermal members 60, 70 which act as thermoelectric coolers in response to an electrical current from a power source 54. Another embodiment illustrates exciters 68, 78 which, in response to an electrical current from a power source 54, cause a magnetic field which causes a thermal change in chemical compounds 69, 79 stored within the ear pieces 22, 24. In either case, the thermal members 60, 70 radiate heat or apply cooling through the ear pieces 22, 24 to heat or cool the individual wearing the headphones 20.

### B. Headphones.

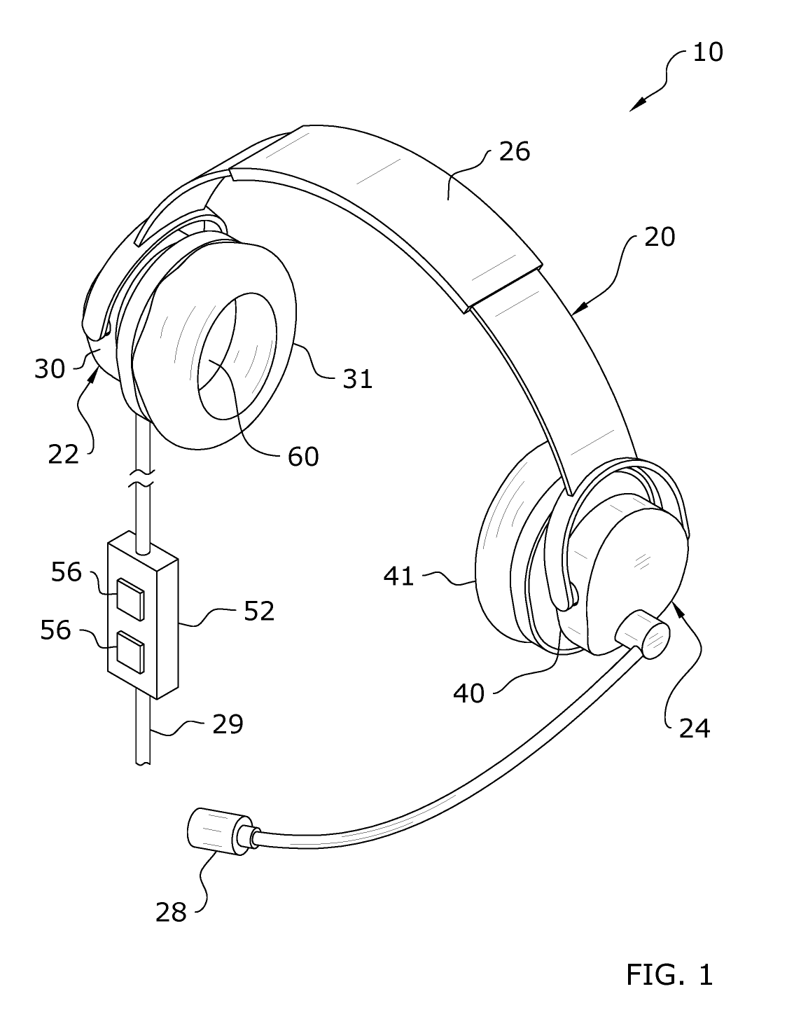

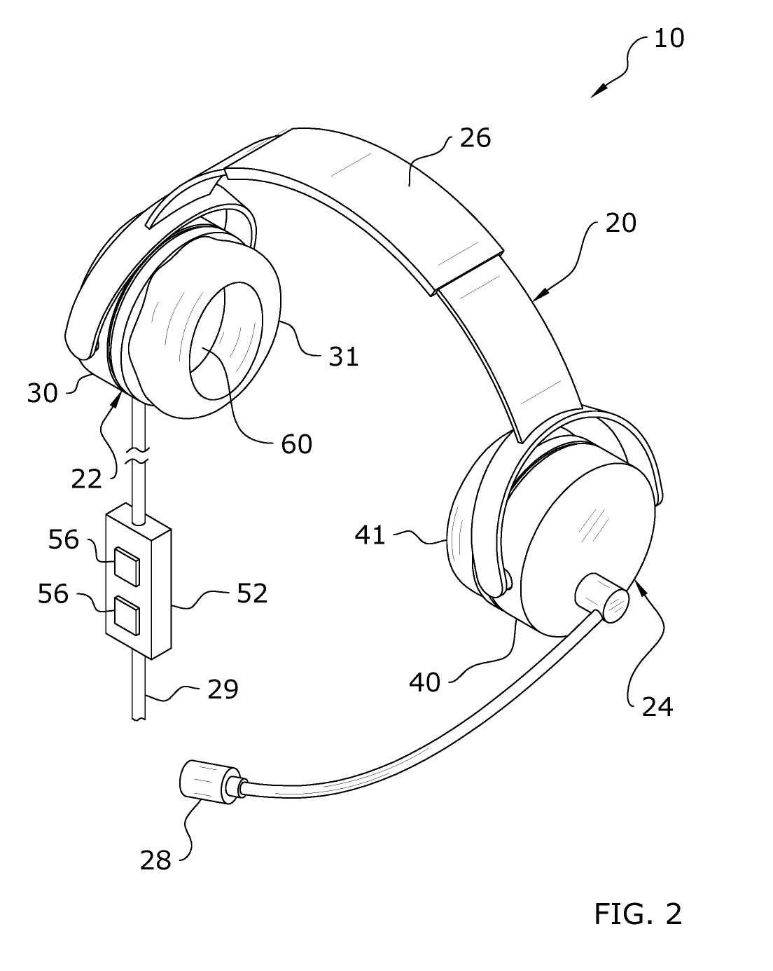

As shown throughout the figures, headphones 20 are disclosed which are generally worn on the head of an individual to cover one or more ears. The headphones 20 may or may not include speakers 32, 42 for playing audio such as music or white noise to help improve a person's ability to fall asleep and stay asleep. The headphones 20 may also in some embodiments comprise a headset having a microphone 29. One such embodiment may comprise an aviator headset 20 commonly used in aviation such as shown in FIGS. 1-2.

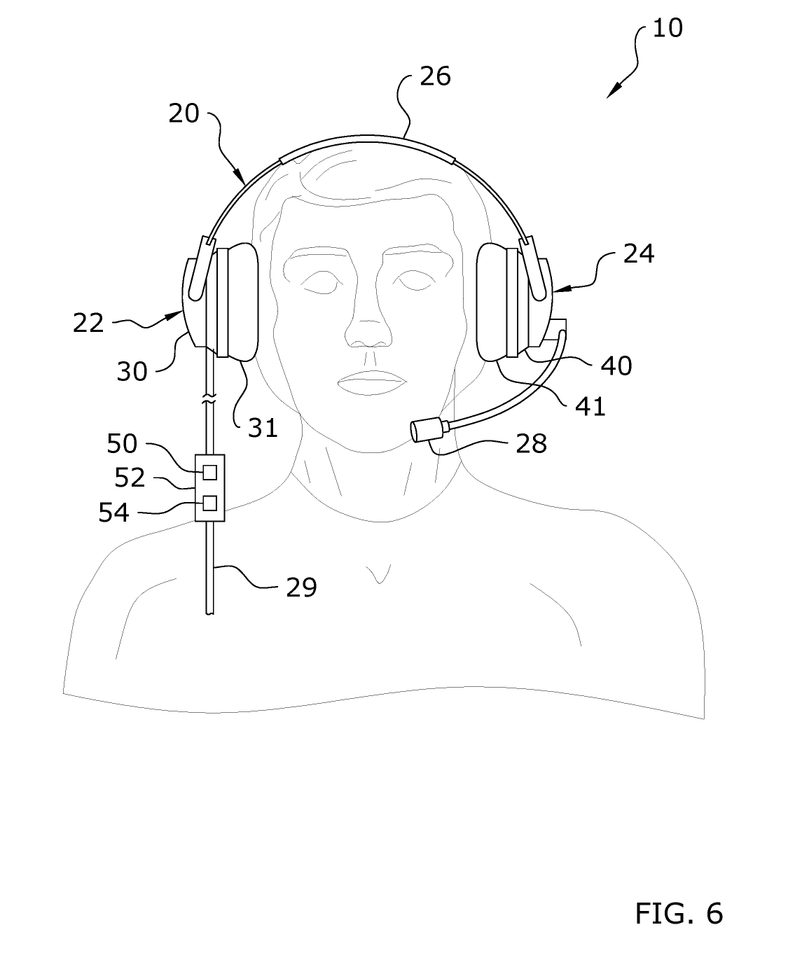

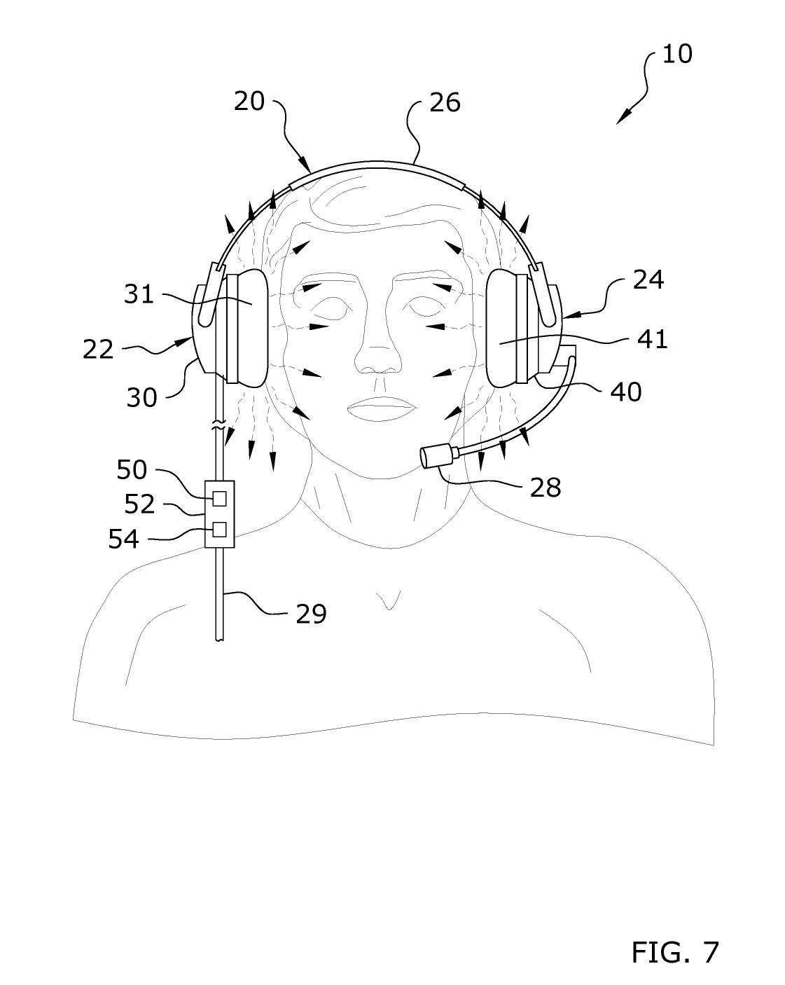

The headphones 20 in the exemplary figures are illustrated as comprising a first ear piece 22 adapted to be worn on or near a first ear of an individual and a second ear piece 24 adapted to be worn on or near a second ear of an individual. It should be appreciated, however, that in some embodiments the headphones 20 may only include a single ear piece 22. The ear pieces 22, 24 are illustrated in FIGS. 6-7 as fully covering the ears, but in some embodiments one or more of the ear pieces 22, 24 may only partially cover the ears or fit within the ears. Thus, the ear pieces 22, 24 need not necessarily fully surround the ears when worn.

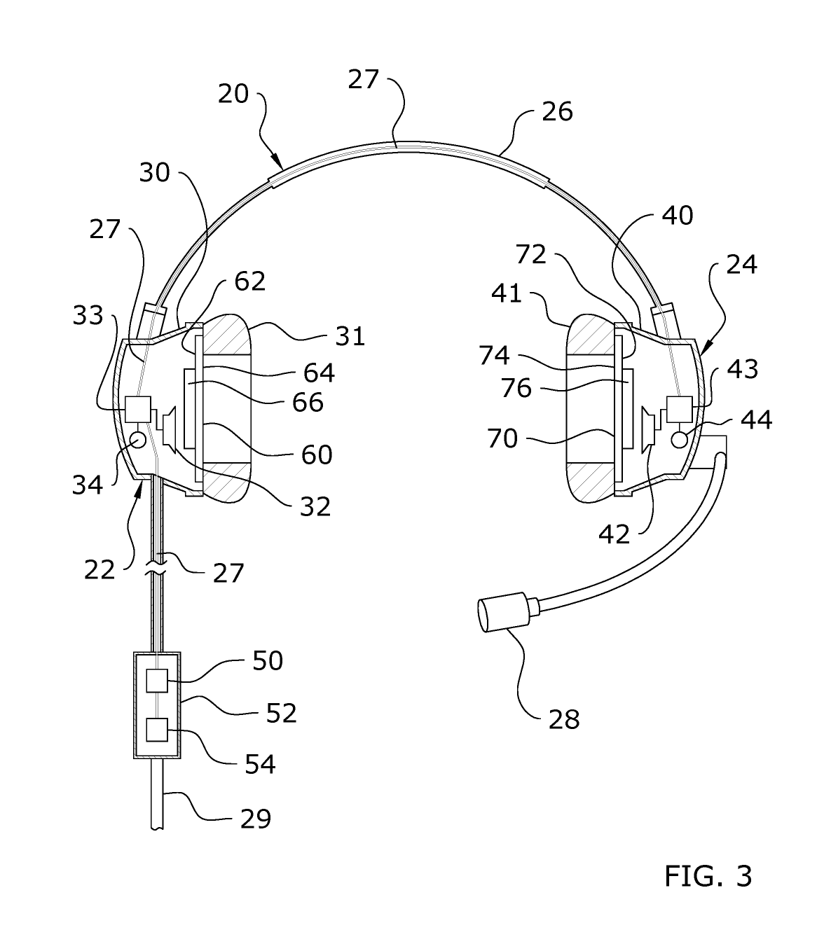

As best shown in FIGS. 3-5, embodiments which utilize two ear pieces 22, 24 may include a headpiece 26 which connects the first ear piece 22 with the second ear piece 24. The headpiece 26 may comprise a curved, elongated member of a semi-rigid material, such as plastic, which is positioned over or behind the head when the headphones 20 are worn by an individual. Various other types of head pieces 26 known in the art for use with headphones 20 may also be utilized without affecting overall operation of the systems and methods described herein.

The exemplary headpiece 26 shown in the figures should not be construed as limiting on the scope of the present invention, as a wide range of headpieces 26 may be utilized with the methods and systems described herein. In some embodiments, the headpiece 26 may be omitted entirely, with the ear pieces 22, 24 each being independently retained over or near the ears such as by clips or the like.

In embodiments which utilize speakers 32, 42 for audio, the first ear piece 22 may comprise a first speaker housing 30 and the second ear piece 24 may comprise a second speaker housing 40 such as shown in FIGS. 3-5. It should be appreciated that, in some embodiments, the headphones 20 may only include a first speaker housing 30. The speaker housings 30, 40 may be integrated and of a unitary structure with the ear pieces 22, 24 or may be separate structures which are interconnected.

The shape, size, and configuration of the speaker housings 30, 40 may vary in different embodiments and should not be construed as limited by the exemplary figures. For example, FIG. 2 illustrates headphones 20 having flattened speaker housings 30, 40. FIG. 1 illustrates headphones 20 having curved speaker housings 30, 40.

As best shown in FIG. 3, the speaker housings 30, 40 generally house various components of the audio system of the headphones 20. The first speaker housing 30 is illustrated as housing a first speaker 32, first active noise reduction (ANR) device 33, and first fan 34. The second speaker housing 40 is illustrated as housing a second speaker 42, a second active noise reduction (ANR) device 43, and a second fan 44.

It should be appreciated that the figures are merely for exemplary purposes, and thus the components housed within the speaker housings 30, 40 may vary in different embodiments and should not be construed as limited by the exemplary figures. In some embodiments, the controller 50 and power source 54 may be positioned within the speaker housings 30, 40 and not in a separate controller housing 52 as shown in the figures. In some embodiments, the ANR devices 33, 43 and/or fans 34, 44 may be omitted, or other components added.

As shown in FIGS. 6-7, the ear pieces 22, 24 may each include an ear cushion 31, 41. More specifically, the first ear piece 22 may include a first ear cushion 31 and the second ear piece 24 may include a second ear cushion 41. The first ear cushion 31 may be connected to the inner end of the first speaker housing 30 and the second ear cushion 41 may be connected to the inner end of the second speaker housing 40. In some embodiments, the ear cushions 31, 42 may be integrally formed of a unitary structure with the speaker housings 30, 40.

The ear cushions 31, 41 are adapted to fit over and around the ears of the individual. The ear cushions 31, 41 may comprise various soft materials which would be comfortable to wear for an individual. The ear cushions 31, 41 will preferably comprise a material which is suited for transferring heat or cooling from the thermal members 60, 70. Thus, the heat or cooling from the thermal members 60, 70 will preferably transfer through the ear cushions 31, 41 such that the ear cushions 31, 41 heat or cool in a manner which radiates the heat or applies the cooling to the ears of the individual.

In some embodiments, the ear cushions 31, 41 may act as a reservoir or other type of container for a chemical compound 69, 79 which is adapted to heat or cool in response to electrical excitation causing a magnetic field. The chemical compound 69, 79 is discussed in more detail below, but may include a solid, liquid, or gas which is known in the art to undergo thermal changes in response to an electrical current or other electrical excitation.

In embodiments which include such a chemical compound 69, 79, the ear cushions 31, 41 may include an internal reservoir or other space which stores the chemical compound 69, 79. In other embodiments, the ear cushions 31, 41 may themselves be fully or partially comprised of the chemical compounds 69, 79.

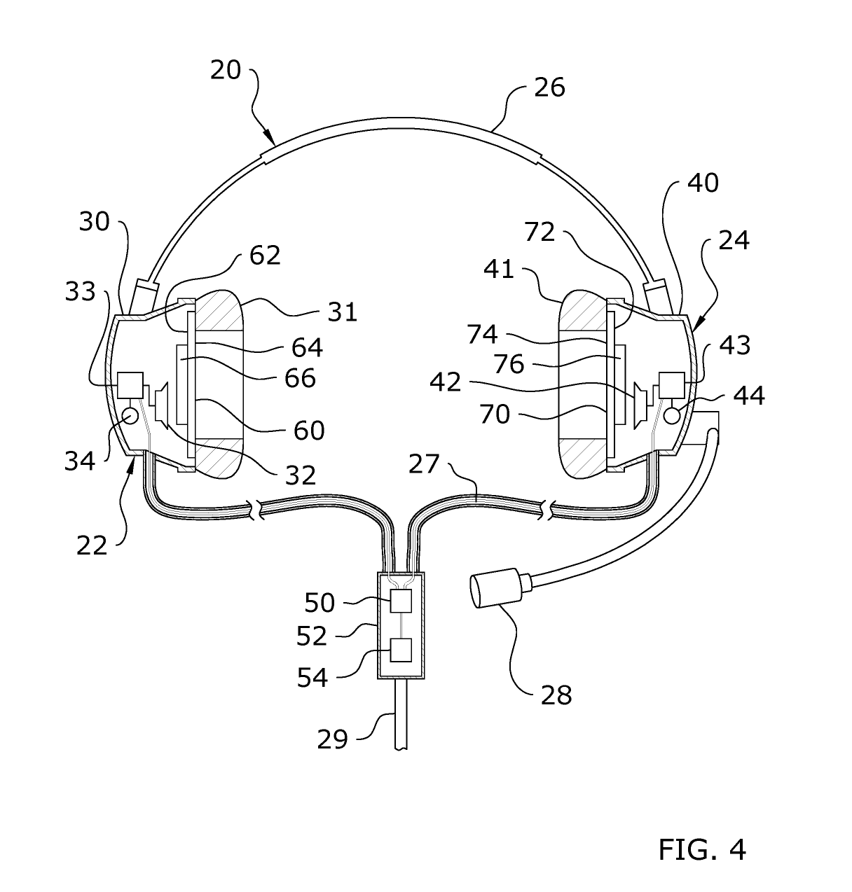

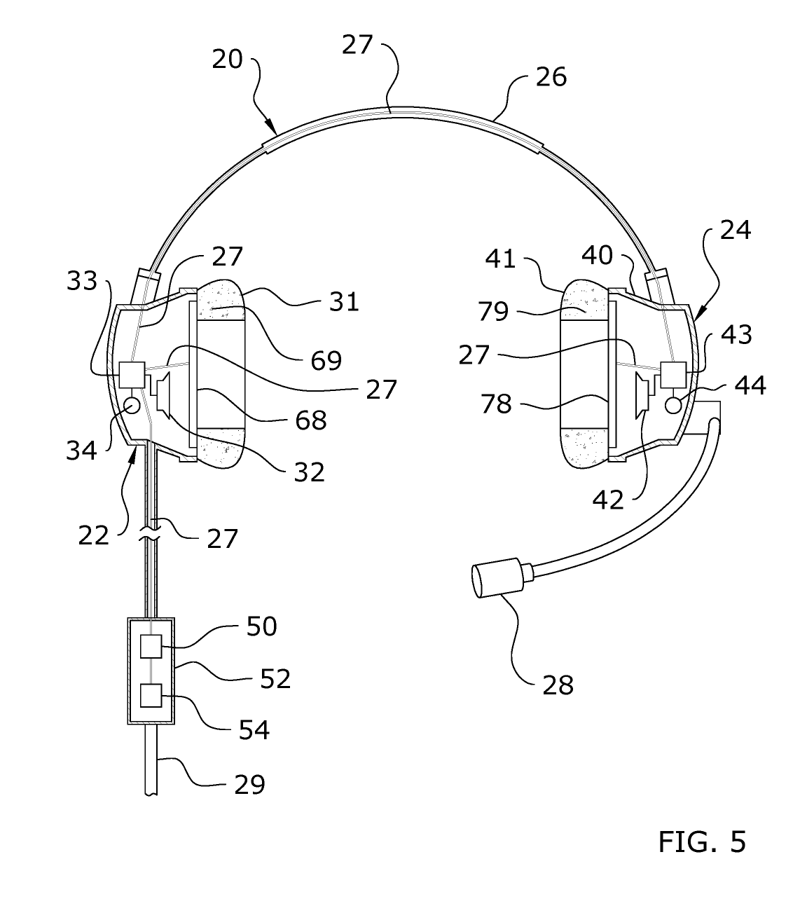

As best shown in FIGS. 1-3, a cord 29 may extend from the headphones 20. The cord 29 may extend from one of the ear pieces 22, 24, such as from the first ear piece 22 as shown in FIG. 3, or may extend from both of the ear pieces 22, 24 as shown in FIG. 4. In embodiments in which a cord 29 extends from each of the ear pieces 22, 24, an internal conduit 27 may interconnect the components of the first ear piece 22 and second ear piece 24 by extending through the headpiece 26 as shown in FIG. 5.

As shown in FIGS. 3-5, the headphones 20 may comprise a controller 50 which controls the speakers 32, 42 and thermal members 60, 70. The controller 50 may be positioned within the ear pieces 22, 24 themselves or may be stored in a separate controller housing 52 such as shown in FIG. 3. The controller housing 52 may be located at various positions along the headphones 20. In the embodiment shown in the figures, the controller housing 52 is connected in-line with the cord 29.

The controller housing 52 will generally house at least the controller 50 and a power source 54. In some embodiments, the controller 50 and power source 54 may be stored in the speaker housings 30, 40. Various types of controllers 50 may be utilized, such as electrical circuitry, programmable logic circuits, digital circuitry, and the like. Similarly, various types of power sources 54 may be utilized, such as various types of batteries and the like. The power source 54 will preferably provide power to both the speakers 32, 42 and the thermal members 60, 70.

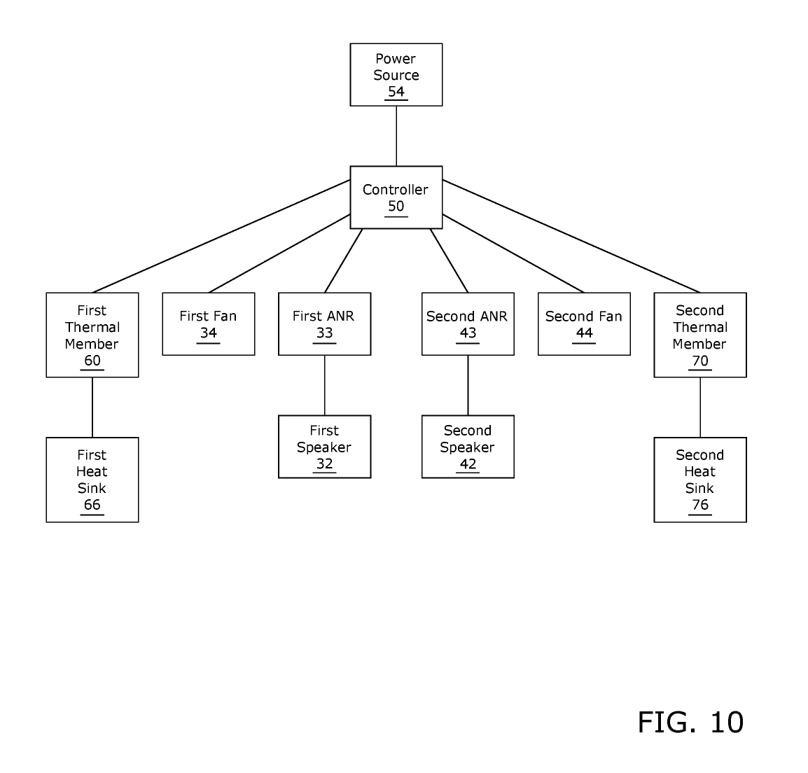

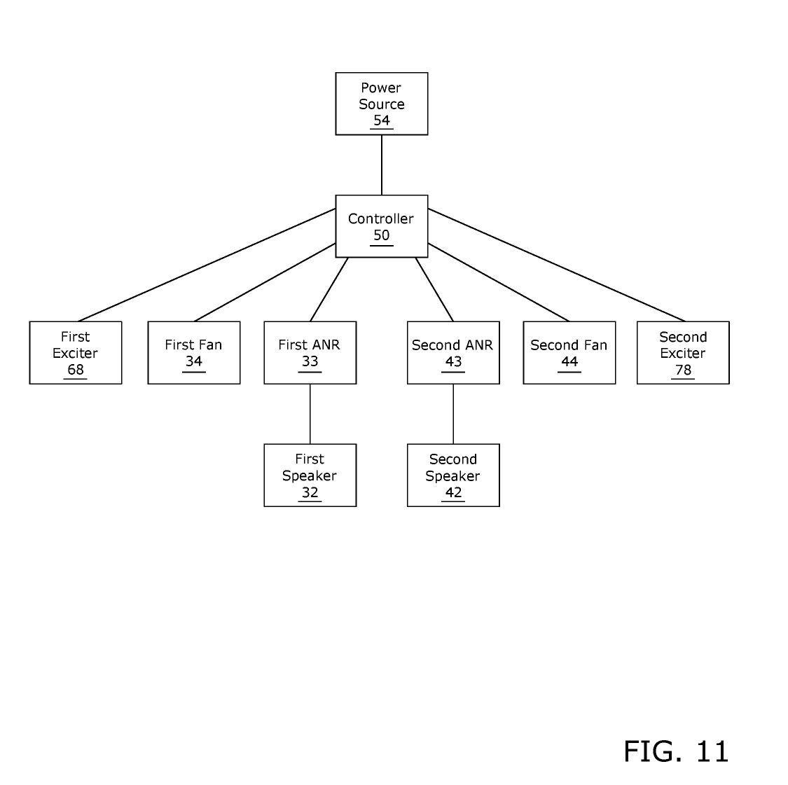

FIGS. 3-5 and 10-11 illustrate exemplary interconnections between the components of the ear pieces 22, 24. As shown, the speakers 32, 42, ANR devices 33, 43, and fans 34, 44 are preferably interconnected with each other and with the controller 50 and power source 54 by the cord 29 and/or internal conduits 27. The controller 50 is preferably interconnected with all of the components so that the controller 50 may control operation of the components.

As shown in FIGS. 1-2, the controller housing 52 may also include buttons 56 on its exterior to allow an individual to control various operations of the headphones 20 such as heating/cooling, volume, and the like. Various types of buttons 56 may be provided, such as a power button, volume buttons, and other controls for activating or deactivating the thermal members 60, 70. Thus, the simple, exemplary arrangement of buttons 56 shown in the figures should not be construed as limiting on the scope of the present invention.

### C. Thermal Members.

As shown throughout the figures, the headphones 20 may include one or more thermal members 60, 70 which are each adapted to provide heating and/or cooling. The thermal members 60, 70 are generally connected to the ear pieces 22, 24 so that the ear pieces 22, 24 may be heated or cooled by the thermal members 60, 70. The heat or cooling from the thermal members 60, 70 is transferred to the ear pieces 22, 24 and the area surrounding the ear pieces 22, 24 to head or cool the individual wearing the headphones 20.

The thermal members 60, 70 may comprise various shapes, sizes, and configurations. In some embodiments, the thermal members 60, 70 may comprise plates which are connected to the ear pieces 22, 24. In other embodiments, the thermal members 60, 70 may comprise other structural configurations so long as the heating/cooling from the thermal members 60, 70 is efficiently distributed to the ear pieces 22, 24.

The thermal members 60, 70 may be directly connected to the ear pieces 22, 24 as shown in the figures or may be connected near the ear pieces 22, 24; so long as the heat/cooling from the thermal members 60, 70 is transferred to the ear pieces 22, 24. In some embodiments, the thermal members 60, 70 may be integrally formed of a unitary structure with the ear pieces 22, 24. In the exemplary figures, the first ear piece 22 includes a first thermal member 60 and the second ear piece 24 includes a second thermal member 70. In embodiments with only a single ear piece 22, only a single thermal member 60 may be used.

The thermal members 60, 70 may comprise various devices, compounds, and the like which exhibit heating or cooling properties in response to stimuli. In the embodiment shown in FIGS. 3-4, 8, and 10, the thermal members 60, 70 each comprise a thermoelectric cooler which is adapted to cool in response to an electric current.

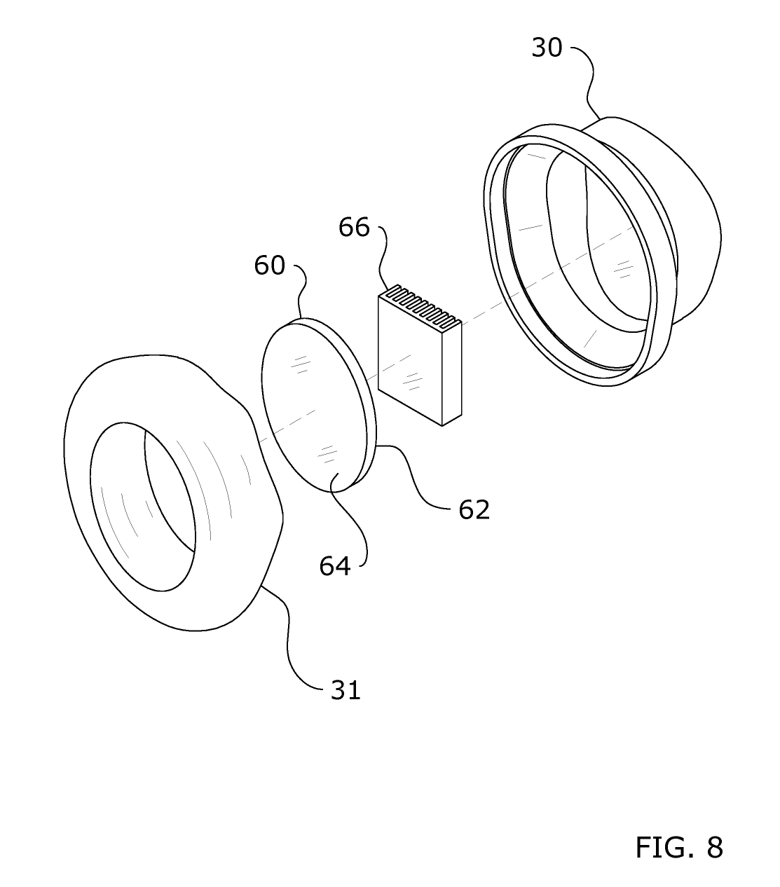

By way of example, one such thermoelectric cooler which functions well as the thermal members 60, 70 is a Peltier thermoelectric cooler. As shown in FIG. 8, such thermal members 60, 70 will generally comprise a cold side 62, 72 and a hot side 64, 74. When electric current is applied to such thermal members 60, 70 to flow through the thermal members 60, 70, heat from the cold side 62, 72 to the hot side 64, 74; thus heating the hot side 64, 74 and cooling the cold side 62, 72.

In the exemplary embodiment shown in FIG. 4, the first thermal member 60 includes a first hot side 62 and a first cold side 64; with the first cold side 64 being connected to the first ear piece 22. Similarly, the second thermal member 70 includes a second hot side 72 and a second cold side 74; with the second cold side 74 being connected to the second ear piece 24. Thus, when an electric current is applied to the thermal members 60, 70, the cold sides 64, 74 will transfer cooling to the ear pieces 22, 24 which is applied to the ears and surrounding area of the individual wearing the headphones 20.

In embodiments with thermoelectric coolers as the thermal members 60, 70, thermal sinks 66, 76 may be desirable to draw away the heat from the hot side 62, 72 of the thermal members 60, 70. As shown in FIGS. 3-4, the first thermal member 60 may include a first thermal sink 66 connected to the first hot side 62 and the second thermal member 70 may include a second thermal sink 76 connected to the second hot side 74.

Such thermal members 60, 70 may be activated by directing an electrical current from the power source 54 through the internal conduits 27 and/or cord 29 to the thermal members 60, 70. The controller 50 may direct the activation or deactivation of the thermal members 60, 70 by starting or ending the electrical current from the power source 54 to the thermal members 60, 70. As discussed below, the operator of the present invention may control the heating/cooling of the thermal members 60, 70 manually in some embodiments by adjusting the electrical current with the controller 50.

FIGS. 5, 9, and 11 illustrate an alternate embodiment which utilizes first and second exciters 68, 78 in combination with chemical compounds 69, 79 within the ear pieces 22, 24 to heat/cool the ear pieces 22, 24. More specifically, such an embodiment may utilize ear pieces 22, 24 which store or are comprised of a chemical compound 69, 79 known to heat or cool in response to electrical excitation.

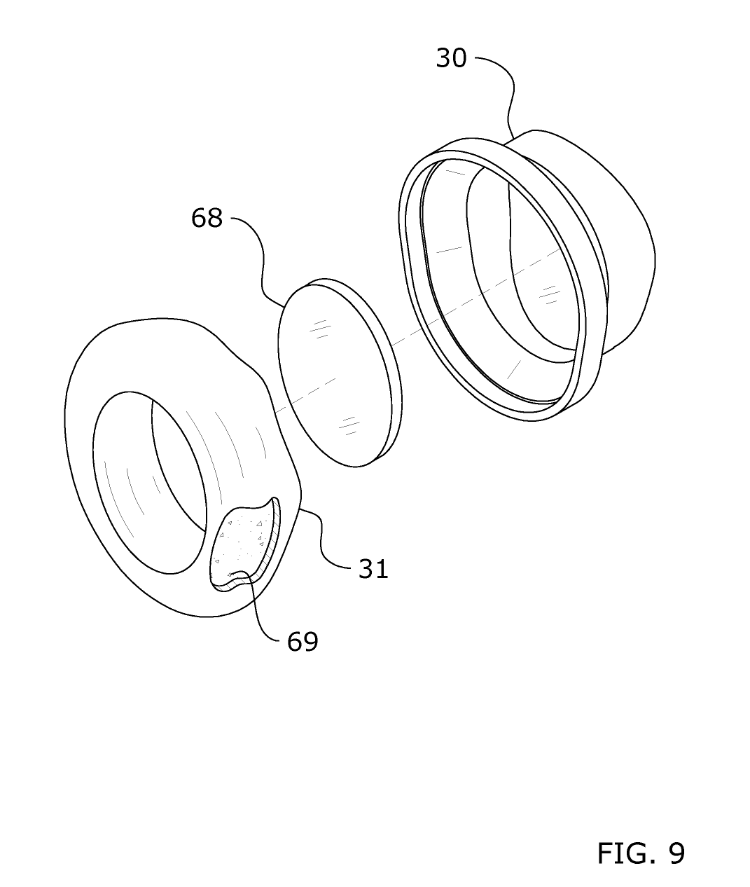

As best shown in FIGS. 5 and 9, such an embodiment may comprise a first exciter 68 connected to the first ear piece 22 and a second exciter 78 connected to the second ear piece 24. Each of the ear pieces 22, 24 includes a chemical compound 69, 79 known to heat or cool in response to electrical excitation from the exciters 68, 78; with the first ear piece 22 including a first chemical compound 69 and the second ear piece 24 including a second chemical compound 79.

In yet another embodiment, the ear cushions 31, 41 may each comprise a disposable phase change material such as sodium acetate. In such embodiments, the ear cushions 31, 41 may be removably connected to the ear pieces 22, 24 such that the ear cushions 31, 41 may be individually removed, stored in a cooler, and then reconnected to the ear pieces 22, 24 after being cooled. The ear cushions 31, 41 may then be disposed of or re-cooled for use again.

### D. Operation of Preferred Embodiment.

In use, the headphones 20 are first put on an individual's head. The ear pieces 22, 24 are positioned on, near, or around the ears. In embodiments which utilize a headpiece 26, the headpiece 26 is positioned over or around the head so that the first ear piece 22 is positioned on, near, or around the first ear and the second ear piece 24 is positioned on, near, or around the second ear as shown in FIG. 6.

With the headphones 20 being worn by the individual, the headphones 20 may then be used. If the headphones 20 include speakers 32, 42, the user may utilize the controller 50 to activate the speakers 32, 42 to play audio. If necessary, the cord 29 of the headphones 20 may be connected to an audio source device such as a smart phone, radio receiver/transmitter, or the like. In other embodiments, the headphones 20 may be connected to the audio source wirelessly; such as via Bluetooth as is known in the art. In embodiments utilizing a microphone 28, such as with an aviation headset, the microphone 28 may be activated or deactivated via the controller 50 as well.

As the headphones 20 are in use, the user may desire to be cooled or heated by the headphones 20. The user may thus activate the thermal members 60, 70 to direct heat or cooling through the ear pieces 22, 24 to heat or cool the ears and head of the individual. The heat will radiate or the cooling will emanate from the thermal members 60, 70 and through the ear pieces 22, 24 to heat or cool the individual wearing the headphones 20 as shown in FIG. 7.

The heat or cooling may be applied through the ear cushions 31, 41 in embodiments which utilize ear cushions 31, 41 by directly heating or cooling the ear cushions 31, 41. The degrees of heating and/or cooling may vary in different embodiments to suit the needs of different individuals. Generally speaking and without limitation, the thermal members 60, 70 may be adapted to cool the ear pieces 22, 24 to between 58 and 65 degrees Fahrenheit. Similarly without limitation, the thermal members 60, 70 may be adapted to heat the ear pieces 22, 24 to between 72 and 86 degrees Fahrenheit.

FIGS. 3, 4, 8, and 10 illustrate an embodiment which utilizes thermal members 60, 70 comprised of thermoelectric coolers such as Peltier thermoelectric coolers. In such embodiments, the operator will first activate the thermal members 60, 70 such as by utilizing the buttons 56 on the controller housing 52.

When so activated, the power source 54 is directed by the controller 50 to apply an electrical current to the thermal members 60, 70. When the electrical current is applied to the thermal members 60, 70, such as by internal conduits 27, heat will be transferred from the cold sides 64, 74 to the hot sides 62, 72. This will cause the hot sides 62, 72 of the thermal members 60, 70 to heat up and the cold sides 64, 74 of the thermal members 60, 70 to cool down.

The heat from the hot sides 62, 72 of the thermal members 60, 70 will preferably be absorbed by the thermal sinks 66, 76. If fans 34, 44 are provided, the fans 34, 44 may be activated to further draw this heat away from the ear pieces 22, 24. Preferably, the fans 34, 44 will be pointed away from the individual wearing the headphones 20 toward the outer end of the ear pieces to draw heat away from the individual. The fans 34, 44 will preferably be positioned to draw heat from the thermal sinks 66, 76.

The cooling from the cold sides 64, 74 of the thermal members 60, 70 is transferred to the ear pieces 22, 24. As the ear pieces 22, 24 cool down, the wearer of the headphones 20 will similarly be cooled. Cooling will be applied directly to the ears via the ear pieces 22, 24 and may also emanate around the ear pieces 22, 24 to cool the individual around his/her ears, such as the temples. When desired, the controller 50 may be utilized to stop the flow of electrical current from the power source 54 to the thermal members 60, 70 and thus stop the cooling effect.

FIGS. 5, 9, and 11 illustrate an embodiment of the headphones 20 which utilizes exciters 68, 78 and chemical compounds 69, 79 to heat/cool the ear pieces 22, 24. In such an embodiment, the controller 50 may be utilized to activate the power source 54 to direct power, such as via the internal conduits, to the exciters 68, 78.

Electrical current entering the exciters 68, 78 creates a magnetic field via electrical excitation which will cause thermal changes in the chemical compounds 69, 79 stored in the ear pieces 22, 24. For example, a magnetic field caused by the exciters 68, 78 may cause the chemical compounds 69, 79 within the ear pieces 22, 24 to cool.

As the chemical compounds 69, 79 within the ear pieces 22, 24 cool, the ear pieces 22, 24 will similarly cool and apply this cooling to the ears and surrounding areas of the individual wearing the headphones 20. The cooling may also emanate around the ear pieces 22, 24 for further cooling. When desired, the controller 50 may be utilized to stop the electrical flow from the power source 54 to the exciters 68, 78 to stop the cooling.

Unless otherwise defined, all technical and scientific terms used herein have the same meaning as commonly understood by one of ordinary skill in the art to which this invention belongs. Although methods and materials similar to or equivalent to those described herein can be used in the practice or testing of the thermally adjustable headphone system, suitable methods and materials are described above. All publications, patent applications, patents, and other references mentioned herein are incorporated by reference in their entirety to the extent allowed by applicable law and regulations. The thermally adjustable headphone system may be embodied in other specific forms without departing from the spirit or essential attributes thereof, and it is therefore desired that the present embodiment be considered in all respects as illustrative and not restrictive. Any headings utilized within the description are for convenience only and have no legal or limiting effect.

What is claimed is:

1. A thermally adjustable headphone system, comprising:
an ear piece adapted to be worn on or near an ear;
a thermal member adapted to heat or cool, wherein the thermal member is connected to the ear piece such that heating or cooling from the thermal member is transferred to the ear piece;
a power source electrically connected to the thermal member; and
a controller for adjusting a temperature of the thermal member.

2. The thermally adjustable headphone system of claim 1, wherein the thermal member is connected behind the ear piece.

3. The thermally adjustable headphone system of claim 1, wherein the thermal member comprises a hot side and a cold side.

4. The thermally adjustable headphone system of claim 3, wherein the ear piece is connected to the cold side of the thermal member.

5. The thermally adjustable headphone system of claim 4, further comprising a thermal sink connected to the thermal member.

6. The thermally adjustable headphone system of claim 5, wherein the thermal sink is connected to the hot side of the thermal member.

7. The thermally adjustable headphone system of claim 1, wherein the thermal member comprises a Peltier thermoelectric cooler.

8. The thermally adjustable headphone system of claim 1, wherein the thermal member comprises an exciter.

9. The thermally adjustable headphone system of claim 8, wherein the ear piece includes a chemical compound adapted to heat or cool when electrically stimulated.

10. The thermally adjustable headphone system of claim 9, wherein the exciter is adapted to electrically stimulate the chemical compound within the ear piece.

11. A thermally adjustable headphone system, comprising:
a first ear piece adapted to be worn on or near a first ear, wherein the first ear piece comprises a first speaker;
a second ear piece adapted to be worn on or near a second ear, wherein the second ear piece comprises a second speaker;
a headpiece connected between the first ear piece and the second ear piece;
a first thermal member connected to the first ear piece, wherein the first thermal member is adapted to apply cooling through the first ear piece;
a second thermal member connected to the second ear piece, wherein the second thermal member is adapted to apply cooling through the second ear piece;
a power source electrically connected to the first thermal member and the second thermal member; and
a controller for adjusting a temperature of the first thermal member and the second thermal member.

12. The thermally adjustable headphone system of claim 11, wherein the first thermal member comprises a first hot side and a first cold side, wherein the second thermal member comprises a second hot side and a second cold side.

13. The thermally adjustable headphone system of claim 12, wherein the first ear piece is connected to the first cold side and the second ear piece is connected to the second cold side.

14. The thermally adjustable headphone system of claim 13, further comprising a first thermal sink connected to the first hot side of the first thermal member and a second thermal sink connected to the second hot side of the second thermal member.

15. The thermally adjustable headphone system of claim 14, wherein the first thermal member and the second thermal member are each comprised of a Peltier thermoelectric cooler.

16. The thermally adjustable headphone system of claim 11, wherein the first thermal member comprises a first exciter and wherein the second thermal member comprises a second exciter.

17. The thermally adjustable headphone system of claim 16, wherein the first ear piece includes a first chemical compound and wherein the second ear piece includes a second chemical compound.

18. The thermally adjustable headphone system of claim 17, wherein the first chemical compound is stored within the first ear piece and wherein the second chemical compound is stored within the second ear piece.

19. The thermally adjustable headphone system of claim 18, wherein the first chemical compound is adapted to cool when an electrical current is applied to the first chemical compound by the power source, wherein the second chemical compound is adapted to cool when the electrical current is applied to the second chemical compound.

20. A thermally adjustable headphone system, comprising:
a first ear piece adapted to be worn on or near a first ear, wherein the first ear piece comprises a first speaker;
a second ear piece adapted to be worn on or near a second ear, wherein the second ear piece comprises a second speaker;
a headpiece connected between the first ear piece and the second ear piece;
a first thermoelectric cooler connected behind the first ear piece, wherein the first thermoelectric cooler comprises a first hot side and a first cold side, wherein the first cold side of the first thermoelectric cooler is connected to the first ear piece such that cooling from the first thermoelectric cooler is applied to the first ear piece;
a second thermoelectric cooler connected to the second ear piece, wherein the second thermoelectric cooler comprises a second hot side and a second cold side, wherein second first cold side of the second thermoelectric cooler is connected to the second ear piece such that cooling from the second thermoelectric cooler is applied to the second ear piece;
a power source electrically connected to the first thermoelectric cooler and the second thermoelectric cooler; and
a controller for adjusting a temperature of the first thermoelectric cooler and the second thermoelectric cooler.
